(19) United States
(12) Patent Application Publication
(10) Pub. No.: US 2017/0136338 A1
(43) Pub. Date: May 18, 2017

(54) EXERCISE INFORMATION MEASURING APPARATUS, PROGRAM, AND CONTROL METHOD

(71) Applicant: OMRON HEALTHCARE CO., LTD., Muko-shi (JP)

(72) Inventors: Mitsuru SAMEJIMA, Kyoto (JP); Takehiro HAMAGUCHI, Kyoto (JP)

(73) Assignee: OMRON HEALTHCARE CO., LTD., Muko-shi (JP)

(21) Appl. No.: 15/418,058

(22) Filed: Jan. 27, 2017

Related U.S. Application Data
(63) Continuation of application No. PCT/JP2015/072356, filed on Aug. 6, 2015.

(30) Foreign Application Priority Data
Aug. 22, 2014 (JP) 2014-169475

(51) Int. Cl. A63B 71/06; A63F 13/85; A63F 13/45; A63B 24/00; A63F 13/34

(52) U.S. Cl. CPC A63B 71/06; A63B 24/0062; A63B 71/0622; A63F 13/34; A63F 13/45; A63F 13/85; A63B 24/0075; A63B 2225/50; A63B 2220/40; A63B 2220/34; A63B 2220/836; A63B 2220/803; A63B 2220/20; A63B 2220/17; A63B 2230/75; A63B 2220/30; A63B 2220/89; A63B 2220/62; A63B 2071/063; A63B 2024/0081

(57) ABSTRACT

An exercise information measuring apparatus includes: a detection unit that detects information corresponding to motion of a user; an exercise information measurement unit that measures exercise information regarding the user based on information detected by the detection unit; a communication unit for performing short-range wireless communication with another apparatus that has a function of measuring exercise information regarding a user; an information acquisition unit that acquires exercise information measured by the other apparatus via the communication unit; and a processing determination unit that determines, based on the radio wave intensity of communication with the other apparatus by the communication unit, whether or not to perform processing that utilizes first exercise information measured by the exercise information measurement unit and second exercise information acquired from the other apparatus.

### TECHNICAL FIELD

The present invention relates to an exercise information measuring apparatus, a program, and a control method.

### BACKGROUND ART

Recent years have seen the active development of exercise information measuring apparatuses that measure exercise information such as an activity amount (number of steps, walking distance, consumed calories, etc.) and a movement speed (walking speed, running speed, etc.) using motion detection sensors that detect body motion, such as acceleration sensors and angular velocity sensors.

Some of these exercise information measuring apparatuses are known to have a short-range wireless communication function, and various services can be provided by using this function.

For example, Patent Literature 1 discloses pedometers that determine walking compatibility by directly exchanging activity intensity data, which is information that depends on the user's walking pitch, with other pedometers and comparing the activity intensities.

Also, although not related to an exercise information measuring apparatus, Patent Literature 2 discloses a technique for sharing information between two devices. Patent Literature 2 discloses a system in which the distance between a master device and a slave device is measured using radio wave field intensity, and an announcement is made if the distance is greater than or equal to a threshold value. In this system, the time intervals at which the master device and the slave device perform communication are controlled according to the speed of movement in the direction of separation of the master device and slave device and according to the movement directions of the master device and slave device.

### CITATION LIST

### Patent Literature

Patent Literature 1: JP 2011-90426A

Patent Literature 2: JP 2006-39709A

### SUMMARY OF THE INVENTION

### Technical Problem

According to Patent Literature 1, by using exercise information regarding multiple users, it is possible to provide users with previously impossible services. in order to promote the use of exercise information measuring apparatuses in the future, it is necessary to provide various applications that utilize exercise information measured by exercise information ineasuring apparatuses.

The technique disclosed in Patent Literature 2 makes it possible to be aware of the relative positional relationship between two devices without using expensive devices such as GPS (Global Positioning System) receivers, but the devices are not exercise information measuring apparatuses, and consideration is not given to applications that utilize exercise information.

The present invention was achieved in light of the above-described circumstances, and an object thereof is to provide an exercise information measuring apparatus, a program, and a control method that can promote usage particularly during a group activity by performing processing that utilizes exercise information measured by the exercise information measuring apparatuses of multiple users.

### Solution to Problem

An exercise information measuring apparatus according to one aspect of the present invention includes: a detection unit that detects information corresponding to motion of a user; an exercise information measurement unit that measures exercise information regarding the user based on information detected by the detection unit; a communication unit for performing short-range wireless communication with another apparatus that has a function of measuring exercise information regarding a user; an information acquisition unit that acquires exercise information measured by the other apparatus via the communication unit; and a processing determination unit that determines, based on a radio wave intensity of communication with the other apparatus by the communication unit, whether or not to perform processing that utilizes first exercise information measured by the exercise information measurement unit and second exercise information acquired from the other apparatus.

A program according to one aspect of the present invention is a program for causing a computer to function as the exercise information measurement unit, the information acquisition unit, and the processing determination unit.

A control method according to one aspect of the present invention is a method of controlling an exercise information measuring apparatus having a detection unit that detects information corresponding to motion of a user, the method including: a first step of measuring exercise information regarding the user based on information detected by the detection unit; a second step of acquiring exercise information measured by another apparatus that has a function of measuring exercise information regarding a user, via a communication unit for performing short-range wireless communication with the other apparatus; and a third step of determining, based on a radio wave intensity of communication with the other apparatus by the communication unit, whether or not to perform processing that utilizes first exercise information measured in the first step and second exercise information acquired in the second step.

### Advantageous Effects of Invention

According to the present invention, it is possible to provide an exercise information measuring apparatus that can promote usage particularly during a group activity by performing processing that utilizes exercise information measured by the exercise information measuring apparatuses of multiple users.

### BRIEF DESCRIPTION OF DRAWINGS

FIG 1 is a diagram showing a schematic configuration of a system 100 for describing a first embodiment of the present invention.

FIG. 2 is a block diagram showing an example of a hardware configuration of an exercise information measuring apparatus 10 in FIG. 1.

FIG. 3 is a diagram showing function blocks realized by a control unit 2 through a processor executing a program stored in a storage unit 5 of the exercise information measuring apparatus 10 in FIG. 2.

FIG. 4 is a flowchart for describing operations of the exercise information measuring apparatus 10 in the system 100.

FIG. 5 is a block diagram showing an example of a hardware configuration of the exercise information measuring apparatus 10 according to a variation.

FIG. 6 is a diagram showing function blocks realized by the control unit 2 through a processor executing a program stored in the storage unit 5 of the exercise information measuring apparatus 10 in FIG. 5.

FIG. 7 is a flowchart for describing operations of the exercise information measuring apparatus 10 in FIG. 5.

FIG. 8 is a block diagram showing an example of a hardware configuration of the exercise information measuring apparatus 10 according to a second embodiment.

FIG. 9 is a diagram showing function blocks realized by the control unit 2 through a processor executing a program stored in the storage unit 5 of the exercise information measuring apparatus 10 in FIG. 8.

FIG. 10 is a flowchart for describing game parameter determination processing executed by the exercise information measuring apparatus 10 in FIG. 8.

### DESCRIPTION OF EMBODIMENTS

Hereinafter, embodiments of the present invention will be described with reference to the drawings. Note that in the following description and accompanying drawings, constituent elements having substantially the same function configuration are denoted by the same reference signs, thereby omitting redundant descriptions.

### First Embodiment of Present Invention

### System Configuration

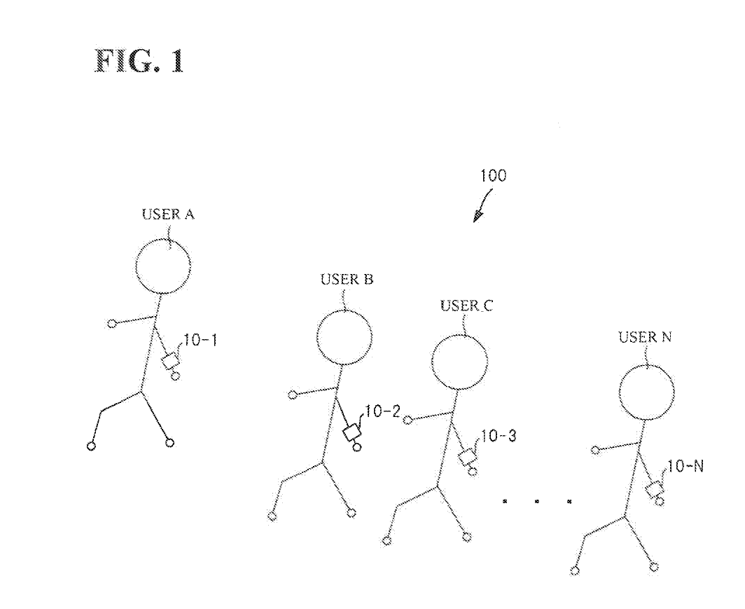

FIG. 1 is a diagram showing the schematic configuration of a system 100 for describing a first embodiment of the present invention. The system 100 includes multiple (N in the example in FIG. 1) exercise information measuring apparatuses 10-1 to 10-N. The exercise information measuring apparatuses 10-1 to 10-N are used while being attached to the user's body, and specific examples thereof include a pedometer, an activity meter, and a sports watch.

The first embodiment describes a system in which, for example, a user A, a user B, . . . a user N are respectively in possession of the exercise information measuring apparatuses 10-1, 10-2, . . . 10-N during a group activity such as mountain climbing, and announcements are made using exercise information measured by the apparatuses.

Note that in order to facilitate understanding of the description, the user A (e.g., a teacher) is considered to be the group leader in the mountain climb, and the exercise information measuring apparatus 10-1 belonging to the user A is set as the master device in advance. Due to the exercise information measuring apparatus 10-1 being set as the master device, the exercise information measuring apparatuses 10-2 to 10-N belonging to the users B to N (students) are set as slave devices. Accordingly, the user A (teacher) can manage the activity of the group (students).

The exercise information measuring apparatuses 10-1 to 10-N each measure exercise information (e.g., movement speed information such as a walking pace) regarding the user to which it is attached. The exercise information measuring apparatus 10-1 uses short-range wireless communication to acquire the user exercise information measured by the exercise information measuring apparatuses 10-2 to 10-N, and gives an announcement (warning) according to differences in exercise information among the devices. Hereinafter, the exercise information measuring apparatuses 10-1 to 10-N are simply referred to as the exercise information measuring apparatus 10 when there is no need to make a distinction between them.

### Configuration of Exercise Information Measuring Apparatus

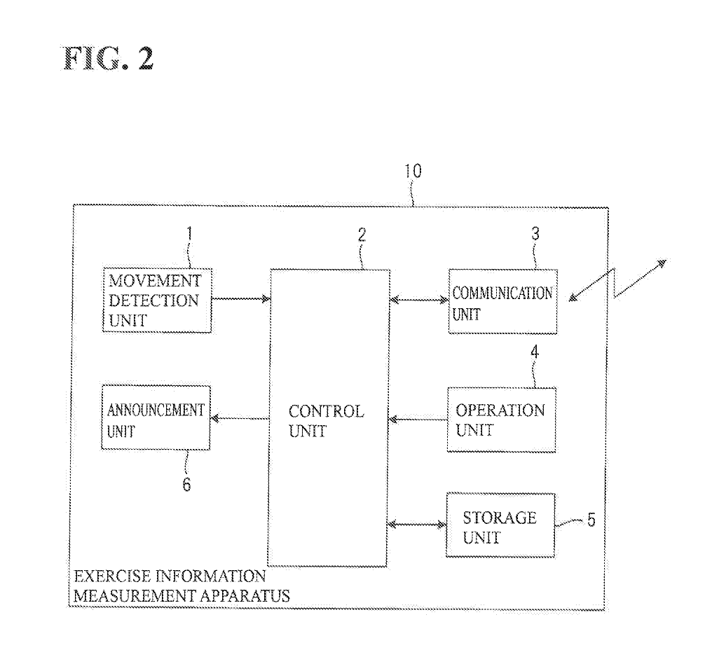

FIG. 2 is a block diagram showing an example of the configuration of the exercise information measuring apparatus 10.

The exercise information measuring apparatus 10 includes a movement detection unit 1, a control unit 2 that performs overall control, a communication unit 3, an operation unit 4, a storage unit 5 that includes a storage medium such as a flash memory or a ROM (Read Only Memory), and an announcement unit 6 for displaying various types of information or outputting audio information.

The movement detection unit 1 detects information (acceleration, angular velocity, etc.) corresponding to motion of the portion of the user's body to which the exercise information measuring apparatus 10 is attached (including the case of being inserted in a clothes pocket). The movement detection unit 1 includes various motion sensors such as an acceleration sensor and an angular velocity sensor, and a signal processing unit that processes signals output by the various motion sensors. It is sufficient that the movement detection unit 1 includes at least one motion sensor and a signal processing unit that processes signals from that motion sensor.

The control unit 2 is mainly constituted by a processor that executes programs stored in the ROM of the storage unit 5.

The communication unit 3 is an interface for performing short-range wireless communication with electronic devices including other exercise information measuring apparatuses 10. Short-range wireless communication refers to communication that is compliant with a communication standard that enables performing direct communication between devices without using a network such as the Internet. Examples of this interface include an ANT-compliant communication interface and a communication interface compliant with Bluetooth (registered trademark).

The operation unit 4 is a device for inputting various instructions to the control unit 2, and is constituted by buttons, a touch panel installed on the announcement unit 6, or the like.

The storage unit 5 stores information detected by the movement detection unit 1, stores information received via the communication unit 3, and stores information necessary for operation of the exercise information measuring apparatus 10.

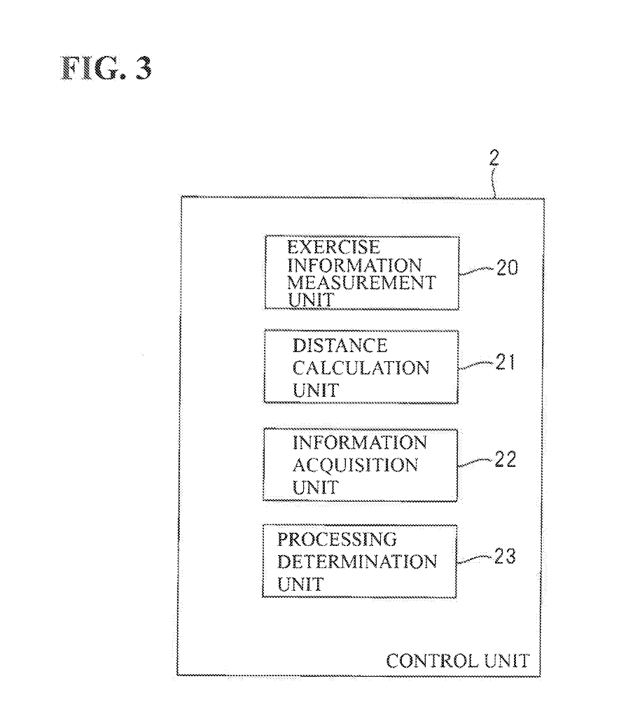

FIG. 3 is a diagram showing function blocks realized by the control unit 2 through the processor executing a program stored in the storage unit 5 of the exercise information measuring apparatus 10 in FIG. 2,

As shown in FIG. 3, the control unit 2 includes an exercise information measurement unit 20, a distance calculation unit 21, an information acquisition unit 22, and a processing determination unit 23.

The exercise information measurement unit 20 measures exercise information regarding the user based on information detected by the movement detection unit 1. The exercise information can include a user activity amount (number of steps, walking distance, consumed calories, etc.) and a movement speed, but includes at least the movement speed. The movement speed is information indicating the speed of movement, such as a walking speed or a running speed.

The distance calculation unit 21 calculates the distance to another exercise information measuring apparatus 10 (referred to hereinafter as another apparatus 10) based on the radio wave intensity of communication with the other apparatus 10 by the communication unit 3. The higher the communication radio wave intensity is, the smaller the calculated distance is, whereas the lower the communication radio wave intensity is, the larger the calculated distance is. Accordingly, the communication radio wave intensity is information that reflects the distance to the other apparatus 10.

The information acquisition unit 22 acquires the movement speed measured by the exercise information measurement unit 20, and stores it in the storage unit 5 in association with identification information regarding the own apparatus.

The information acquisition unit 22 also acquires the distance to the other apparatus 10 calculated by the distance calculation unit 21, and stores the acquired distance in the storage unit 5 in association with identification information regarding the other apparatus 10. The information acquisition unit 22 also acquires the movement speed measured by the other apparatus 10 via the communication unit 3, and stores it in the storage unit 5 in association with the identification information regarding the other apparatus 10.

Accordingly, for each other apparatus 10 that can be communicated with, the storage unit 5 stores other apparatus information that includes the distance to the own apparatus and information indicating the movement speed. This other apparatus information is periodically updated along with the own apparatus information.

The processing determination unit 23 checks the other apparatus information regarding one of the other apparatuses 10 stored in the storage unit 5, and determines based on the distance included in that other apparatus information whether or not processing is to be performed with use of both the movement speed of the own apparatus included in the own apparatus information and the movement speed of the other apparatus 10 included in the other apparatus information.

The following describes operations of the system 100 of the first embodiment having the configuration described above.

### Operations of Exercise Information Measuring Apparatus

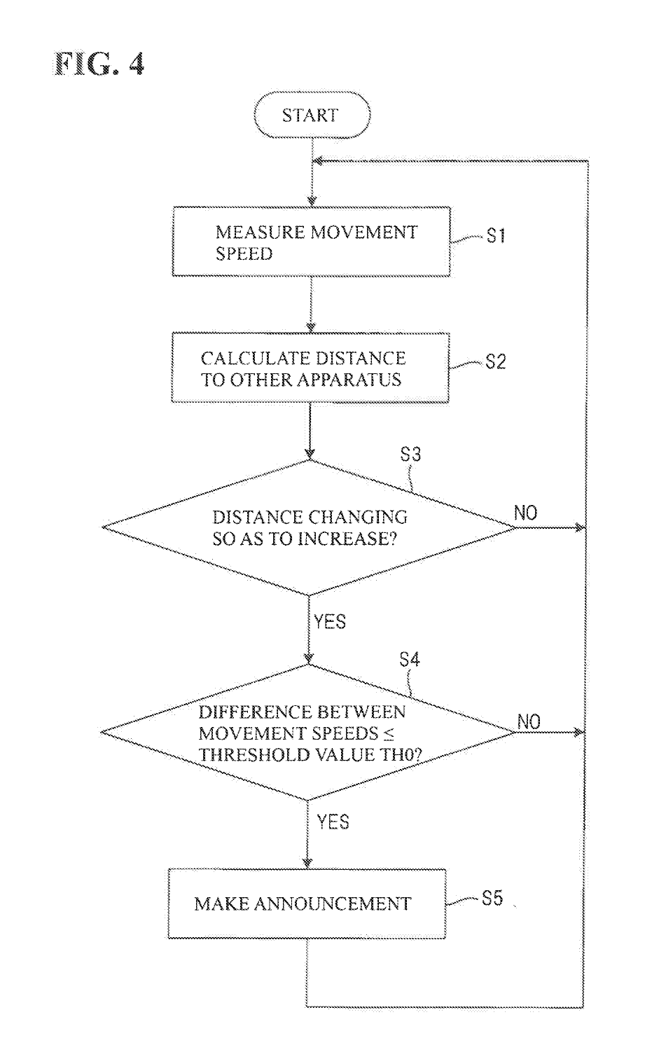

FIG. 4 is a flowchart for describing operations of the exercise information measuring apparatus 10 in the system 100. FIG. 4 shows operations performed by the exercise information measuring apparatus 10 that is the master with respect to one other apparatus 10 (the exercise information measuring apparatus 10-2 in the following description), but the operations in FIG. 4 are similarly performed with respect to each of the other apparatuses 10.

First, the users A to N that are participating in a group activity respectively attach the exercise information measuring apparatuses 10-1 to 10-N, and give an instruction to start measuring exercise information by operating the operation unit 4. The processing flow shown in FIG. 4 is started in accordance with this instruction. Note that the exercise information measuring apparatus 10-1 has been set as the master device in advance by the user A.

The control unit 2 of the exercise information measuring apparatus 10-1 that is the master device measures the movement speed and stores it in the storage unit 5. The control unit 2 of the exercise information measuring apparatus 10-1 also acquires the movement speed measured by the exercise information measuring apparatus 10-2 and identification information regarding the same via the communication unit 3, and stores them it association with each other in the storage unit 5 (step S1).

The control unit 2 of the exercise information measuring apparatus 10-1 calculates the distance to the exercise information measuring apparatus 10-2 based on the radio wave intensity of communication with the exercise information measuring apparatus 10-2 by the communication unit 3, and stores the calculated distance in the storage unit 5 in association with the identification information regarding the exercise information measuring apparatus 10-2 (step S2).

The control unit 2 of the exercise information measuring apparatus 10-1 then reads out the other apparatus information regarding the exercise information measuring apparatus 10-2 stored in the storage unit 5, and determines whether or not the distance between the own apparatus and the exercise information measuring apparatus 10-2 is changing so as to increase, based on the other apparatus information that was read out (step S3).

In the case of determining that the distance from the exercise information measuring apparatus 10-2 to the own apparatus is changing so as to increase (synonymous with the radio wave intensity of communication with the own apparatus changing so as to become weaker) (step S3: YES), the control unit 2 of the exercise information measuring apparatus 10-1 furthermore determines whether or not the difference between the movement speed included in the other apparatus information of the exercise information measuring apparatus 10-2 and the movement speed of the own apparatus included in the own apparatus information is less than or equal to a threshold value TH0 (step S4).

If this difference is less than or equal to the threshold value TH0 (step S4: YES), the control unit 2 of the exercise information measuring apparatus 10-1 determines that the user B in possession of the exercise information measuring apparatus 10-2 is moving in a different direction from the user A in possession of the exercise information measuring apparatus 10-1, and outputs warning information using the announcement unit 6 (step S5). Accordingly, the message “User B is moving in a different direction” is displayed or output as audio by the announcement unit 6, thus alerting the user A.

If the result of the determination in step S3 or step S4 is negative, the control unit 2 of the exercise information measuring apparatus 10-1 returns to step Sl and repeats the above-described processing.

Also, after making the announcement in the processing of step S5, the control unit 2 of the exercise information measuring apparatus 10-1 returns to step S1 and repeats the above-described processing, The above processing is repeated periodically (e.g., once a minute).

### Effects of First Embodiment of Present Invention

As described above, according to the system 100, the group leader (e.g., teacher) can manage the activity of group members (students) during a group activity. According to this configuration, it is possible to promote the use of the exercise information measuring apparatuses during a group activity.

### Variation of First Embodiment of Present Invention

In the first embodiment of the present invention, using the distance between the own apparatus and the other apparatus 10 (corresponding to the radio wave intensity of communication with the other apparatus 10 by the communication unit 3) as a trigger, the control unit 2 determines whether or not to perform processing that utilizes the movement speed measured by the other apparatus 10 and the movement speed measured by the own apparatus, that is to say, processing for determining whether or not to output warning information to the user of the own apparatus based on the difference between the two movement speeds.

A feature of the following variation is the provision of an orientation detection unit in the exercise information measuring apparatus. Using information from the orientation detection unit, the exercise information measuring apparatus predicts the amount of time required for the other apparatus 10 to arrive at the current position of the own apparatus (e.g., the target arrival position of the group activity), and makes an announcement.

### Configuration of Exercise Information Measuring Apparatus of Variation

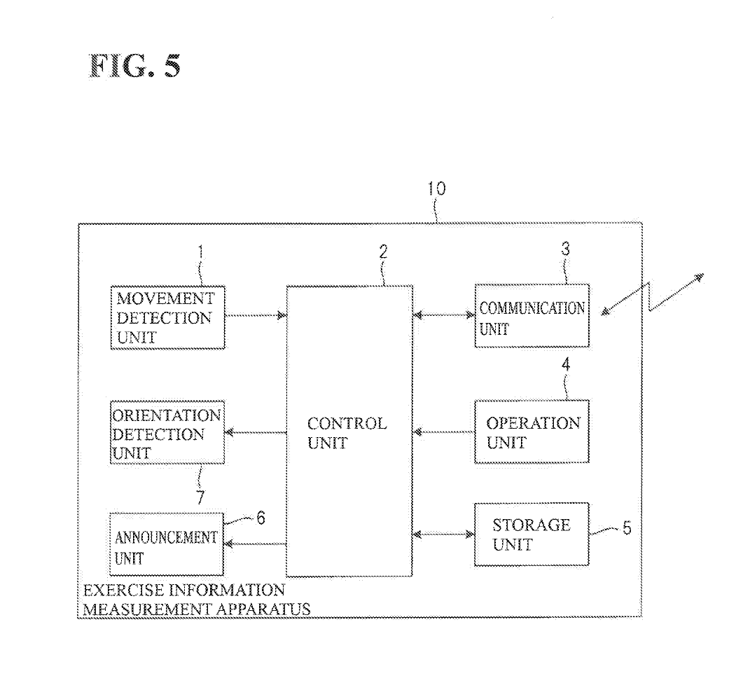

FIG. 5 is a block diagram showing the configuration of the exercise information measuring apparatus 10 of this variation. The exercise information measuring apparatus 10 shown in FIG. 5 is provided with an orientation. detection unit 7, and other aspects are basically the same as in the example of the configuration of the exercise information measuring apparatus 10 shown in FIG. 2.

The orientation detection unit 7 detects the orientation of the exercise information measuring apparatus 10, and is a magnetic field sensor or the like.

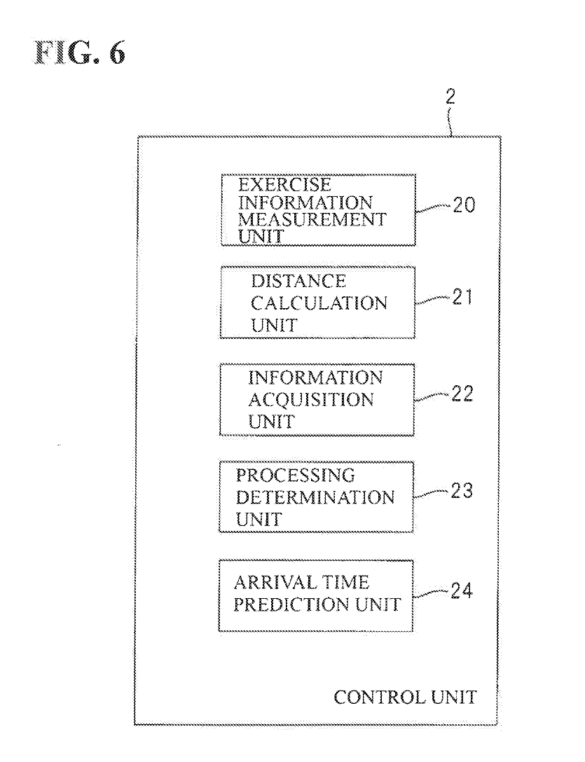

FIG. 6 is a diagram showing function blocks realized by the control unit 2 through the processor executing a program stored in the storage unit 5 of the exercise information measuring apparatus 10 in FIG. 5.

As shown in FIG. 6, the control unit 2 includes the exercise information measurement unit 20, the distance calculation unit 21, the information acquisition unit 22, the processing determination unit 23, and an arrival time prediction unit 24.

The information acquisition unit 22 acquires the movement speed measured by the exercise information measurement unit 20 and the orientation detected by the orientation detection unit 7, associates them with identification information regarding the apparatus to obtain own apparatus information, and stores the own apparatus information in the storage unit 5.

The information acquisition unit 22 also acquires the distance to the other apparatus 10 calculated by the distance calculation unit 21, and stores the acquired distance in the storage unit 5 in association with identification information regarding the other apparatus 10. The information acquisition unit 22 also acquires the movement speed and the orientation measured by the other apparatus 10 via the communication unit 3, and stores them in the storage unit 5 in association with identification information regarding the other apparatus 10.

Accordingly, for each other apparatus 10 that can be communicated with, the storage unit 5 stores other apparatus information that includes the distance to the own apparatus and information indicating the movement speed and the orientation. This other apparatus information is periodically updated along with the own apparatus information.

The arrival time prediction unit 24 performs processing for predicting the amount of time required for the other apparatus 10 to arrive at a target arrival point (e.g., the position where the own apparatus is located) based on the movement speed of the own apparatus included in the own apparatus information, the movement speed of the other apparatus 10 included in the other apparatus information, and the distance included in the other apparatus information.

The processing determination unit 23 determines whether or not the arrival time prediction unit 24 is to perform time prediction processing, based on the orientations included in the own apparatus information and the other apparatus information and the distance included in the other apparatus information.

### Operations of Exercise Information Measuring Apparatus

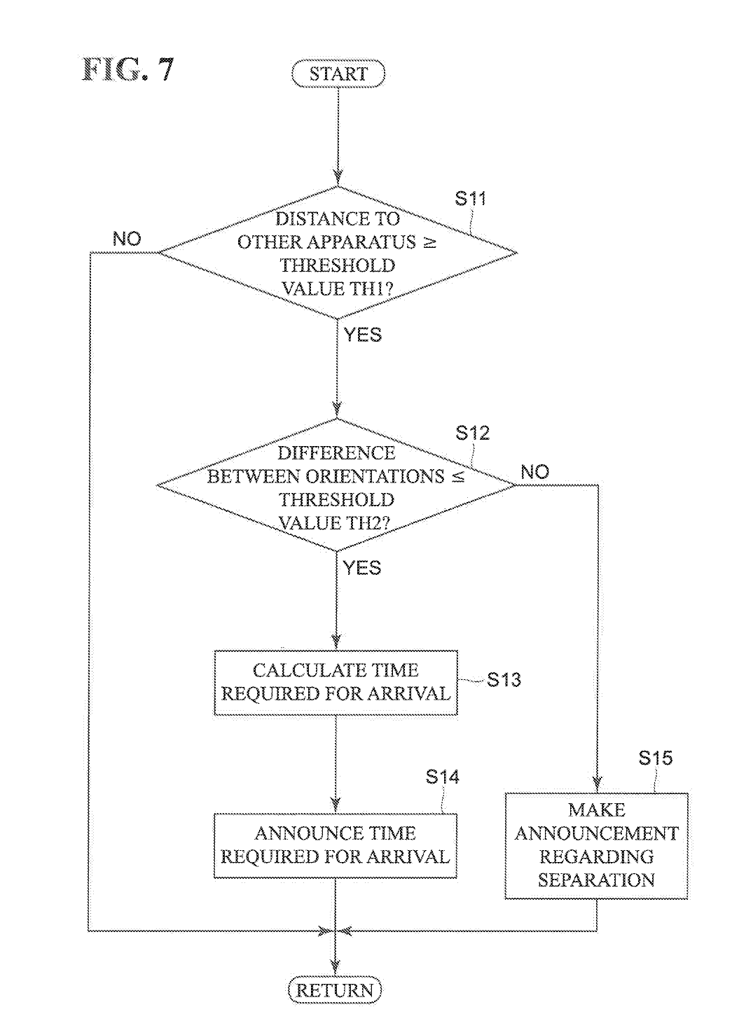

FIG. 7 is a flowchart for describing operations of the exercise information measuring apparatus 10 in FIG. 5. FIG. 7 shows operations performed by the exercise information measuring apparatus 10 that is the master with respect to one other apparatus 10, but the operations in FIG. 7 are similarly performed with respect to each of the other apparatuses 10.

Based on the other apparatus information stored in the storage unit 5, the control unit 2 determines whether or not the distance between the own apparatus and the other apparatus 10 is greater than or equal to a threshold value TH1 (step S11). If the result of the determination in step S11 is negative, that is to say if the distance between the own apparatus and the other apparatus 10 is small, this means that the user in possession of the other apparatus 10 is already at the same position as the user in possession of the own apparatus (target arrival point), and therefore no announcement is made, and the determination of step S11 is performed again.

If the result of the determination in step S11 is affirmative, the control unit 2 determines whether or not the difference between the orientations of the own apparatus and the other apparatus 10 is less than or equal to a threshold value TH2.

If the result of the determination in step S12 is affirmative, the control unit 2 calculates (predicts) the amount of time required for the user in possession of the other apparatus 10 to arrive at the current position of the own apparatus based on the difference between the movement speed of the own apparatus and the movement speed of the other apparatus 10, as well as the distance between the own apparatus and the other apparatus 10 (step S13).

The control unit 2 then announces the predicted amount of time required for arrival that was calculated (step S14). Accordingly, the message “User B will arrive in about 5 minutes” can be displayed or output as audio by the announcement unit 6 so as to alert the user A.

If the result of the determination in step S12 is negative, the control unit 2 skips the processing of step S13 and step S14, and makes an announcement similar to that of step S5 (step S15). After step S14 and step S15, processing returns to step S11.

As described above, according to the system 100, even if the group leader (e.g., teacher) and a group member (student) become separated from each other during a group activity, as long as the directions of advancement of the two are the same, it is possible to predict how much time will be required for the group member to arrive at the destination, and the group leader can thus perform activity management. According to this configuration, it is possible to promote the use of the exercise information measuring apparatuses during a group activity.

### Second Embodiment of Present Invention

Next, a second embodiment of the present invention will be described.

The system 100 of the second embodiment has the same configuration as shown in FIG. 1, and also has a feature in that game functions are provided in the exercise information measuring apparatuses 10-1 to 10-N.

### Configuration of Exercise Information Measuring Apparatus

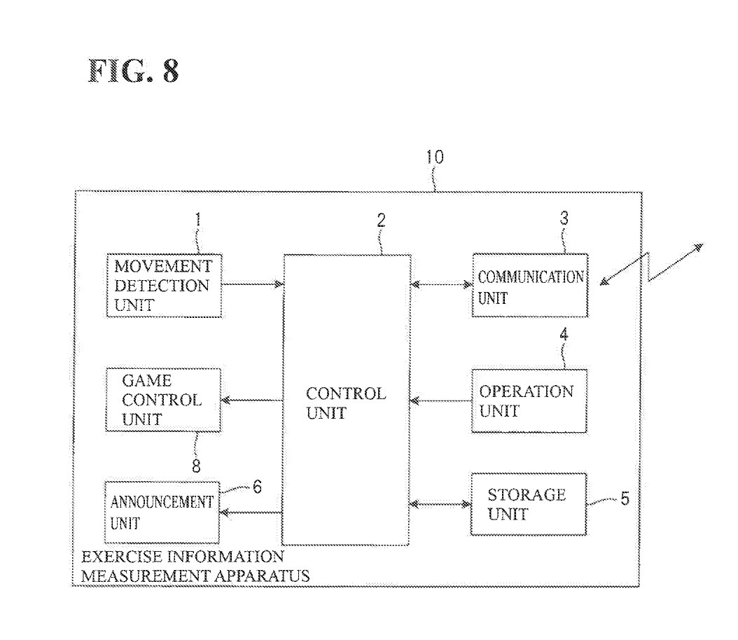

FIG. 8 is a block diagram showing the configuration of the exercise information measuring apparatus 10 according to the second embodiment. The exercise information measuring apparatus 10 shown in FIG. 8 is provided with a game control unit 8, and other aspects are basically the same as in the example of the configuration of the exercise information measuring apparatus 10 shown in FIG. 2.

The game control unit 8 is constituted by a processor that has a built-in memory. A game program is stored in this memory. By the processor executing this game program, a game screen is displayed on the announcement unit 6, and an electronic game played on the game screen is provided.

The game control unit 8 controls parameters in the electronic game, which is based on the game program, based on either of or both exercise information measured by the exercise information measuring apparatus 10 and exercise information that was measured by another apparatus 10 and acquired via the communication unit 3. In the case of a character-based game, for example, examples of the electronic game parameters include the growth rate of a character form.

Note that although there are no particular limitations on the provided electronic game, one example is a game in which the goal is to change the form of characters. Although the game screen is displayed on the announcement unit 6 in the present embodiment, there is no limitation to this, and the exercise information measuring apparatus 10 may be provided with a display unit dedicated to displaying the game screen.

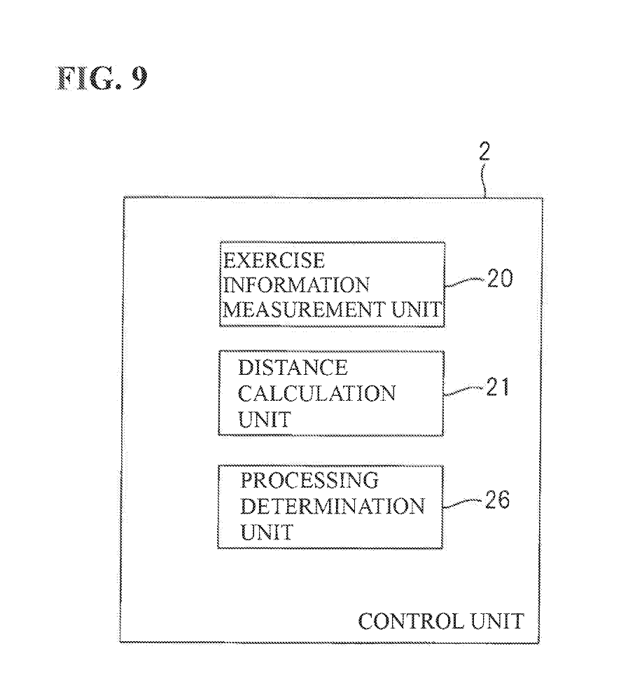

FIG. 9 is a diagram showing function blocks realized by the control unit 2 through the processor executing a program stored in the storage unit 5 of the exercise information measuring apparatus 10 in FIG. 8.

As shown in FIG. 9, the control unit 2 includes the exercise information measurement unit 20, the distance calculation unit 21, and a processing determination unit 26.

The exercise information measurement unit 20 measures exercise information regarding the user based on information detected by the movement detection unit 1. This exercise information includes at least inthrmation indicating an activity amount such as the number of steps, the walking distance, or the number of consumed calories. The exercise information is assumed to indicate the number of steps in the following description.

Based on the distance to the other apparatus 10 calculated by the distance calculation unit 21, the processing determination unit 26 determines whether or not to perform processing that utilizes the number of steps measured by the exercise information measurement unit 20 and the number of steps measured by the other apparatus 10.

Specifically, this processing is processing for calculating the sum of the number of steps measured by the exercise information measurement unit 20 and the number of steps measured by the other apparatus 10 that is the communication partner, and determining the electronic game parameter according to the sum of the number of steps.

### Game Parameter Determination Processing

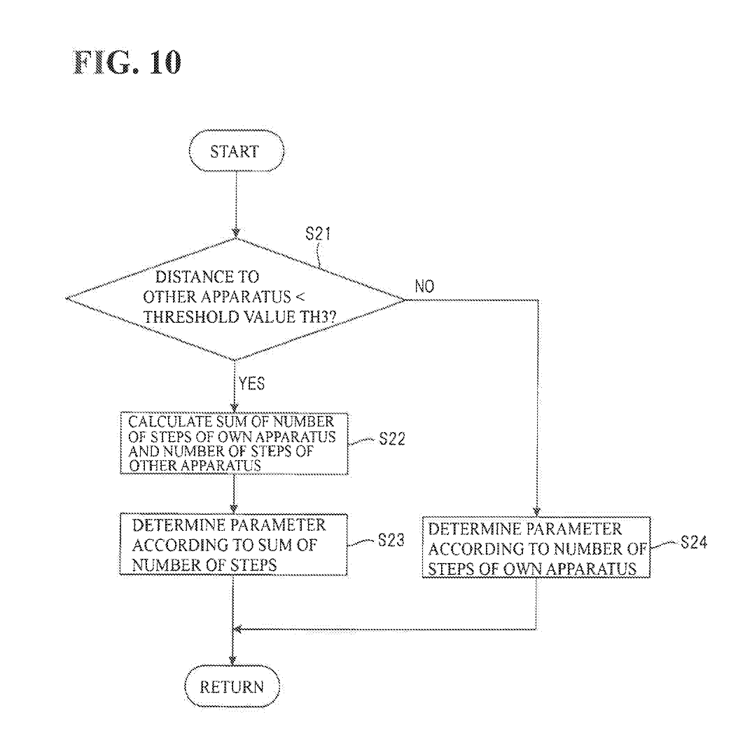

FIG. 10 is a flowchart for describing game parameter determination processing executed by the exercise information measuring apparatus 10 in FIG. 8. FIG. 10 shows operations performed by the exercise information measuring apparatus 10 that is the master with respect to one other apparatus 10, but the operations in FIG. 10 are similarly performed with respect to each of the other apparatuses 10.

When the users A to N respectively attach the exercise information measuring apparatuses 10-1 to 10-N and perform an activity, exercise information is measured by the control unit 2 of each of the apparatuses and stored in the storage unit 5. When an exercise information measuring apparatus 10 performs communication with another apparatus 10, identification information regarding the other apparatus 10 and the exercise information measured by the other apparatus 10 are stored in the storage unit 5 of the exercise information measuring apparatus 10.

The control unit 2 determines whether or not the distance between the own apparatus and the other apparatus 10 is greater than or equal to a threshold value TH3 (step S21).

In the case of determining that the distance between the own apparatus and the other apparatus 10 is less than the threshold value TH3 (step S21: YES), the control unit 2 calculates the sum of the number of steps measured by the own apparatus and the number of steps measured by the other apparatus 10 (step S22). The control unit 2 then determines the electronic game parameter according to the sum of the number of steps (step S23). Accordingly, the game control unit 8 can control the electronic game based on the parameter determined by the control unit 2.

In the case of determining that the distance between the own apparatus and the other apparatus 10 is greater than or equal to the threshold value TH3 (step S21: NO), the control unit 2 determines the electronic game parameter according to only the number of steps measured by the own apparatus (step S24). Accordingly, the game control unit 8 can control the electronic game based on the parameter determined by the control unit 2. Note that the electronic game parameter is set such that a greater number of steps is more advantageous to game progression (e.g., accelerates character growth).

### Effects of Second Embodiment of Present Invention

As described above, according to the system 100, the growth of a character in the electronic game can be accelerated if multiple users wearing exercise information measuring apparatuses 10 perform an activity together while playing the game. In other words, users will play together more often in order to accelerate the growth of their characters, thus making it possible to eliminate a lack of user exercise and also promote an increase in communication. Also, by detecting that users are playing in proximity to each other with use of the radio wave intensity of communication by the communication unit 3, this detection can be made more precisely than when using a GPS receiver to detect that users are playing in proximity to each other.

Note that the present invention is also applicable to a service in which it is envisioned that multiple people are exercising in a predetermined area.

For example, assume that multiple people are exercising (e.g., running) while wearing exercise information measuring apparatuses 10. One person is set as the instructor, and the others are set as students.

The control unit 2 of the exercise information measuring apparatus 10 belonging to the instructor determines the distance to another apparatus 10 belonging to a student, and, if that distance is less than or equal to a threshold value, compares the exercise information (e.g., running speed) measured by the own apparatus and the exercise information (e.g., running speed) measured by the other apparatus 10, and transmits an announcement signal to the other apparatus 10 if the distance between them has become large.

When the other apparatus 10 receives the announcement signal, the announcement unit 6 displays advice such as “Your pace has slowed down. Speed up your pace.” On the other hand, if the distance exceeds the threshold value, the control unit 2 of the exercise information measuring apparatus 10 belonging to the instructor does not perform any processing with respect to the other apparatus 10.

In this way, it is possible for only students in a predetermined range to receive advice that is based on the difference from the instructor's exercise information.

The present invention can also be realized as a program for causing a computer to function as the units shown in FIGS. 3, 6, and 9, and such a program can be provided by being recorded on a non-transitory computer-readable recording medium.

Examples of a computer-readable recording medium include optical media such as a CD-ROM (Compact Disc-ROM) and magnetic recording media such as a memory card. Such a program can also be provided by being downloaded via a network.

The embodiments disclosed above are to be understood as being in all ways exemplary and in no way limiting. The scope of the present invention is defined not by the aforementioned descriptions but by the scope of the appended claims, and all changes which come within the meaning and range of equivalency of the scope of the claims are intended to be included therein as well.

As described above, the present specification discloses the following matter.

The disclosed exercise information measuring apparatus includes: a detection unit that detects information corresponding to motion of a user; an exercise information measurement unit that measures exercise information regarding the user based on information detected by the detection unit; a communication unit for performing short-range wireless communication with another apparatus that has a function of measuring exercise information regarding a user; an information acquisition unit that acquires exercise information measured by the other apparatus via the communication unit; and a processing determination unit that determines, based on a radio wave intensity of communication with the other apparatus by the communication unit, whether or not to perform processing that utilizes first exercise information measured by the exercise information measurement unit and second exercise information acquired from the other apparatus.

In the disclosed exercise information measuring apparatus, the first exercise information and the second exercise information may each indicate a movement speed, and if the communication radio wave intensity changes so as to decrease, the processing determination unit may perform, as the processing, processing for determining whether or not to output warning information according to a difference between the first exercise information and the second exercise information.

The disclosed exercise information measuring apparatus may further include an orientation detection unit, the information acquisition unit may further acquire orientation information detected by an orientation detection unit of the other apparatus; and the processing determination unit may determine whether or not to perform the processing based on the communication radio wave intensity, first orientation information detected by the orientation detection unit, and second orientation information acquired from the other apparatus.

In the disclosed exercise information measuring apparatus, the first exercise information and the second exercise information may each indicate a movement speed, and if the communication radio wave intensity is less than or equal to a first threshold value, and furthermore a difference between an orientation based on the first orientation information and an orientation based on the second orientation information is less than or equal to a second threshold value, the processing determination unit may perform, as the processing, processing for predicting an amount of time required for the other apparatus to move to a target arrival point based on the first exercise information, the second exercise information, and a distance to the other apparatus that is based on the communication radio wave intensity.

The disclosed program is a program for causing a computer to function as the exercise information measurement unit, the information acquisition unit, and the processing determination unit.

A method of controlling the disclosed exercise information measuring apparatus is a method of controlling an exercise information measuring apparatus having a detection unit that detects information corresponding to motion of a user, the method including: a first step of measuring exercise information regarding the user based on information detected by the detection unit; a second step of acquiring exercise information measured by another apparatus that has a function of measuring exercise information regarding a user, via a communication unit for performing short-range wireless communication with the other apparatus; and a third step of determining, based on a radio wave intensity of communication with the other apparatus by the communication unit, whether or not to perform processing that utilizes first exercise information measured in the first step and second exercise information acquired in the second step.

### INDUSTRIAL APPLICABILITY

According to the present invention, it is possible provide an exercise information measuring apparatus, a program, and a control method that can promote usage during a group activity.

While the present invention has been described with reference to specific embodiments, the present invention is not limited to these embodiments, and many variations and modifications can be made without departing from the technical idea of the present invention.

This application claims the benefit of Japanese Patent Application No. 2014-169475, filed Aug. 22, 2014, which is hereby incorporated by reference herein in its entirety.

### REFERENCE SIGNS LIST

10-1˜10-N Exercise information measuring apparatus
1 Movement detection unit
2 Control unit
3 Communication unit
6 Announcement unit
7 Orientation detection unit
20 Exercise information measurement unit
21 Distance calculation unit
22 Information acquisition unit
23 Processing determination unit
24 Arrival time prediction unit

1. An exercise information measuring apparatus comprising:
a detection unit that detects information corresponding to motion of a user;
an exercise information measurement unit that measures exercise information regarding the user based on information detected by the detection unit;
a communication unit for performing short-range wireless communication with another apparatus that has a function of measuring exercise information regarding a user;
an information acquisition unit that acquires exercise information measured by the other apparatus via the communication unit; and
a processing determination unit that determines, based on a radio wave intensity of communication with the other apparatus by the communication unit, whether or not to perform processing that utilizes first exercise information measured by the exercise information measurement unit and second exercise information acquired from the other apparatus.

2. The exercise information measuring apparatus according to claim 1,
wherein the first exercise information and the second exercise information each indicate a movement speed, and
if the communication radio wave intensity changes so as to decrease, the processing determination unit performs, as the processing, processing for determining whether or not to output warning information according to a difference between the first exercise information and the second exercise information.

3. The exercise information measuring apparatus according to claim 1,
further comprising an orientation detection unit,
wherein the information acquisition unit further acquires orientation information detected by an orientation detection unit of the other apparatus, and
the processing determination unit determines whether or not to perform the processing based on the communication radio wave intensity, first orientation information detected by the orientation detection unit, and second orientation information acquired from the other apparatus.

4. The exercise information measuring apparatus according to claim 3,
wherein the first exercise information and the second exercise information each indicate a movement speed, and
if the communication radio wave intensity is less than or equal to a first threshold value, and furthermore a difference between an orientation based on the first orientation information and an orientation based on the second orientation information is less than or equal to a second threshold value, the processing determination unit performs, as the processing, processing for predicting an amount of time required for the other apparatus to move to a target arrival point based on the first exercise information, the second exercise information, and a distance to the other apparatus that is based on the communication radio wave intensity.

5. A program for causing a computer to function as the exercise information measurement unit, the information acquisition unit, and the processing determination unit according to claim 1.

6. A method of controlling an exercise information measuring apparatus having a detection unit that detects information corresponding to motion of a user, the method comprising:
a first step of measuring exercise information regarding the user based on information detected by the detection unit;
a second step of acquiring exercise information measured by another apparatus that has a function of measuring exercise information regarding a user, via a communication unit for performing short-range wireless communication with the other apparatus; and
a third step of determining, based on a radio wave intensity of communication with the other apparatus by the communication unit, whether or not to perform processing that utilizes first exercise information measured in the first step and second exercise information acquired in the second step.
